(19) United States
(12) Patent Application Publication
(10) Pub. No.: US 2013/0159015 A1
(43) Pub. Date: Jun. 20, 2013

(54) SURGERY MONITOR SYSTEM

(71) Applicant: Charles David O'CON, Natchitoches, LA (US)

(72) Inventor: Charles David O'CON, Natchitoches, LA (US)

(21) Appl. No.: 13/329,642

(22) Filed: Dec. 19, 2011

(51) Int. Cl. G06Q 50/24

(52) U.S. Cl. 705/3

(57) ABSTRACT

A surgery monitor system and method for preventing wrong site surgery is disclosed. The first embodiment of the surgery monitor system is comprised of a portable storage device such as an SD card attached to a patient armband. A recording device connected to the smart card by a cable records patient identification indicia recorded by the patient and/or others as well as surgery related information such as patient related health issues, surgery body location, and type of surgery. The recorded information may then be played back by a playback device during subsequent steps of the operation preparation, execution, and post-operative events. Alternate embodiments are presented, including use of a smartphone type device that reads identification barcodes on the patient armband, records and plays back the patient recording and stores the recorded information using an encrypted wireless connection to a server.

### TECHNICAL FIELD

The present invention relates to surgery monitor systems, more particularly to surgery monitor systems that prevent wrong site surgery (WSS).

### BACKGROUND OF THE DISCLOSURE

Wrong site surgery refers to the execution of the wrong procedure, execution on the wrong body part, or on the wrong person. Wrong site surgery and wrong site medical procedures are not an infrequent, and often-tragic, occurrence. Due to the complex multi-step procedures (surgeon schedules the surgery, admittance to surgery facility, preparation of patient including administering regional pain blocks and placing invasive lines, scrubbing/prepping the operation site, patient transfer to the surgery room/procedure room, verbal/written timeouts for verifying the procedure to be done and its steps, the actual surgery, transfer of the patient to recovery area, and after surgery follow-ups) and multiple people involved (administrative, admission staff, nurses and nursing aides, surgical team (one or more surgeons, assistants, surgical technologist), anesthetist, and patient transporter), mistakes can happen. It is estimated (Ref. 1) that in 2007, 597 wrong site surgeries were reported, and that only 10% of actual wrong site surgeries that occurred were actually reported. Taking these statistics at face value, close to 6000 wrong site surgeries are estimated to occur each year.

In the ideal world of unlimited time, personnel and monetary resources, the patient would be admitted to the facility. Then the patient's surgeon would meet the patient upon admission and place his mark on the surgical site after reviewing the patient's medical record. The patient would then go to the operating room fully awake and alert. The surgical site would be prepared and draped, the awake patient would then be identified by the surgeon. Together they would verify the procedure to be done and then anesthesia would be induced. This ideal world does not exist. In today's medical environment, providers offset the cost of decreasing reimbursements with increased surgical case volume. Often, the first time the surgeon sees his patient on an operative day is after the patient is unconscious and covered with surgical drapes. Surgeons typically perform many procedures in a day, often working at different facilities within a given day. A system for reducing the incident of wrong site surgery and medical errors is imperative.

Various procedures and apparatus are used to prevent wrong site surgery. They employ various techniques for verifying the correct patient identification, medical history, the location of the surgery, and the type of surgery to be performed. The most common techniques use patient armband markings to identify the patient (e.g. name, date of birth (DOB), facility medical record number, social security number, and admission date); other markings on the patient armband that indicate the type of surgery to be performed, and marking on the body part where the surgery is to be performed. These identifiers are then compared to the medical record and a written/computerized verification of the information is conducted by the surgical staff.

More sophisticated techniques use computer-hosted databases that store patient identification history, patient health, allergies, and recent medical related information, and employ various recording procedures and mechanisms, e.g. video and audio data and text data that is provided by the patient, the patient's nurses, doctors, and/or caregivers that may be relevant to the procedure to be performed. However, there is a need for a procedure and apparatus for recording patient identification and planned surgery that is simple to implement, relatively inexpensive as compared to the cost of implementing other technology-based systems, that will protect the privacy of the patient information, and can be implemented with currently available commercial products, yet will accommodate future technologies as they emerge.

Ref. 1: Patient Safety and Quality: An Evidence-Based Handbook for Nurses. Hughes R G, editor. Rockville (Md.): Agency for Healthcare Research and Quality (US); 2008 April Chapter 36 Wrong-Site Surgery: A Preventable Medical Error.

### SUMMARY OF THE DISCLOSURE

The first embodiment of the present invention and its variations present a wrong site surgery prevention system for preventing wrong site medical procedures on a patient wearing a patient armband, the patient armband having patient identification indicia such as patient name, date of birth and facility admissions date. The system is comprised of a recording device such as a video camera and/or audio recorder for recording patient video and audio data; a portable storage device for storing the recorded patient multimedia data, a securing device that attaches the portable storage device to the patient armband; a playback device for playing back the recorded patient multimedia data; and mechanisms for operationally connecting the portable storage device to the recording device and to the playback device. Examples of portable storage devices currently widely available are SD cards (micro or mini) and thumb drives. The portable storage devices currently available typically have a storage capacity of two GB or higher. Two methods for operationally connecting the portable storage device to the recording device and to the playback device are a) using a cable designed to operationally connect the two devices, or b) by actually removing the portable storage device from the patient armband and attaching it to the recording device and/or playback device as appropriate. Recording devices currently and widely available include video recorders, digital cameras, smartphone type devices, and digital tablets that include cable connections having USB ports. More sophisticated devices are anticipated as the technology advances; the inventive concepts presented herein will apply equally to them.

The procedure for using the surgery monitor system, in abbreviated form, is as follows:
1. Upon preparing for the surgery, preferably the patient, but alternately the patient admissions clerk, guardian, caregiver, nurse, or other qualified staff prepares a recording, prompted by the person operating the recording device, that describes three types of information: a) patient identification information such as name, date of birth, b) health related data such as allergies, health issues and relevant medical history, and c) planned procedure-related information such as procedure location, procedure type, and the surgeon's name. The recording is stored on the portable storage device. Ideally, the digital information is secured to the patient's armband upon admission to the facility and is not removed until discharged from the facility.
2. During the surgery preparation procedures such as scrub preparation, preparation at the surgery operation room by the anesthetist and nurses, and a time-out before the surgery is initiated, the recording is played back and verified by both visual inspection (patient's face, surgery site markings), and comparison of the recorded patient identification information with patient armband indicia and the patient chart. When the surgeon is about to begin the operation (he or she may have just entered the room after performing another surgery in a different room), the recording can be played once again, further verifying the agreement of the recorded patient multimedia data with the other available information. As other surgical team members enter the procedure room to join the procedure in progress, the video/audio verification may be replayed for these team members, allowing them to then verify the correct procedure and patient.
3. Optionally, additional information may be recorded by the preparation team and the surgery team prior, during, and after the surgery to update the record for surgery and post surgery consideration.
4. The initially recorded patient data can be replayed at any point during the patient's stay in the hospital.

### BRIEF DESCRIPTION OF THE DRAWINGS

FIG. 1A illustrates an SD card attachable to a patient armband using a first attachment tab of the first embodiment of the present invention.

FIG. 1B illustrates an SD card attachable to a patient armband using a second attachment tab of an alternate embodiment of the present invention.

FIG. 1C illustrates a mini and a micro SD card.

FIG. 2 illustrates the SD card connected to a video camera using a cable of the first embodiment of the present invention.

FIG. 3 illustrates the patient's SD card connected to a playback device using a cable of the first embodiment of the present invention.

FIG. 4 illustrates a flowchart implementing a method use at the surgery facility to use the surgery monitor system of the first embodiment of the present invention.

FIG. 5 illustrates an alternate embodiment of the present invention wherein a smartphone or tablet type device stores and plays back recorded information on a storage device wirelessly connected to the smartphone or tablet type device.

### LIST OF NUMERALS

102—portable storage device

104—patient armband

106—patient identification indicia

108—first attachment tab

109—first hole

110—second attachment tab

111—second attachment hole

112—mini SD card

113—third attachment hole

114—micro SD card

202—patient

204—cable

206—first serial connector element

208—serial wire

210—second serial connector element

212—recording device

304—video playback device

306—intravenous feed

308—oxygen mask

310—vital sign monitor

312—vital sign cable

402—method

404—card step

406—camera step

408—record patient response step

410—disconnect cable step

412—iteration step

414—connect playback device step

416—data consistency step

418—verify step

420—fix step

422—final verify step

502—patient identifying barcode

504—smartphone type device

506—network server

508—multimedia recorder

510—patient Identifying barcode scan

512—encrypted two-way connection

### DETAILED DESCRIPTION

In the following detailed description and appended claims, the following terms are used:
“Patient identification indicia” refers to patient information such as patient age, date of birth, sex, date of admission to surgical facility, and a patient ID number printed on a device such as an armband. The indicia may be printed as text, as an image, and/or stored in a computer-readable format such as a one or two-dimensional barcode.
“Patient multimedia data” refers to patient related information such as patient allergies, illnesses, recent medical procedures, and general health; and procedure related information such as the planned surgical procedure, surgery type, and location on patient body where surgery is to be performed. The information is generated by the patient, patient caregiver or nurse using speech responding to questions, by snapshots, and video and/or audio recordings and is stored in a multimedia format on a multimedia storage device.

The term smartphone type device refers to any recording device such as, but not limited to, an IPad 2, iPhone 4, or Android 2 device that has a video camera and can transmit, receive and playback video by being either hardwired or connected wirelessly to a multimedia storage device. The terms “surgery” and “surgical procedures” refer to any medical procedure that could be done on the wrong patient or at the wrong procedure site. Examples of these procedures include, but are not limited to: surgical procedures, radiological procedures, ultrasonic procedures, heart catheterizations, endoscopic gastrointestinal procedures, acute and chronic pain regional anesthesia procedures, obstetric procedures, dental/oral surgery procedures, bronchoscopy, ophthalmic procedures, dialysis, invasive intravascular/arterial catheter procedures, dermatological procedures, joint manipulations, physical therapy, cosmetic procedures, etc. The term “surgeon” refers to any medical practitioner who is legally allowed to perform the said procedure and includes, but not be limited to: medical doctor, optometrist, podiatrist, dentist, chiropractor, veterinarian, nurse practitioner, certified registered nurse anesthetist, perfusionist, anesthesia assistant, physicians assistant, physical therapist, occupational therapist, a specially trained registered nurse, respiratory therapist or radiation technologist.

It is likely that all computerized components of this surgery monitor system could one day be contained within the armband itself, thus only requiring a simple multimedia monitor for replay. In the current embodiment, the invention utilizes a replay monitor that also has a computer processor/program that initiates the replay of the armband hosted patient multimedia data and allows the provider to interact with the information.

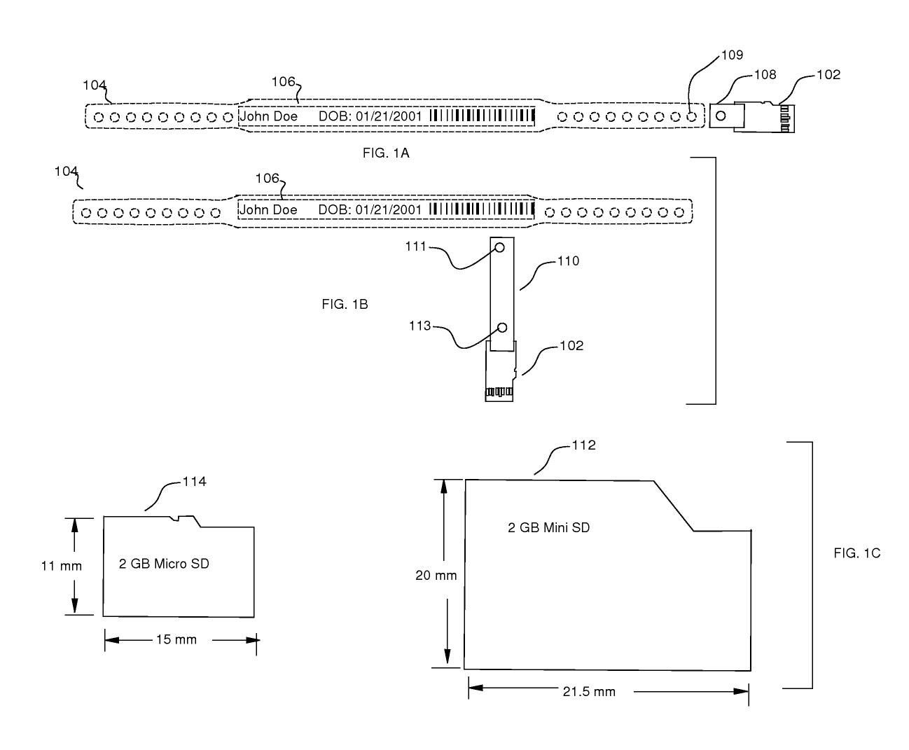

FIG. 1A illustrates a first embodiment of the present invention wherein a portable storage device 102 such as an SD card is attachable to a patient armband 104 using a first attachment tab 108. The patient armband 104 (not part of the first embodiment) has patient identification indicia 106 printed on it. Portable storage device 102 is securely attached to a first attachment tab 108; and first attachment tab 108 is attachable to patient armband 104 via a snap pin (snap pin not shown in the figure) that attaches to a first hole 109 in patient armband 104.

FIG. 1B illustrates a variation of first embodiment wherein a second attachment tab 110 is attachable to patient armband 104 by looping around patient armband 104 and securing the second attachment tab 110 to the patient armband 104 using a snap pin connecting second attachment hole 111 to third attachment hole 113.

FIG. 1C illustrates, in expanded scale, two examples of SD cards 102, a mini SD card 112, and a micro SD card 114. Standard storage capacity of these cards as of this writing is two GB, but enhanced cards of up to 16 GB and more are currently available. The heights of the mini SD card 112, 20 mm (0.78 in), and micro SD card 114, 11 mm (0.43 in), are compatible with the width of patient armband 104 that is typically about one inch.

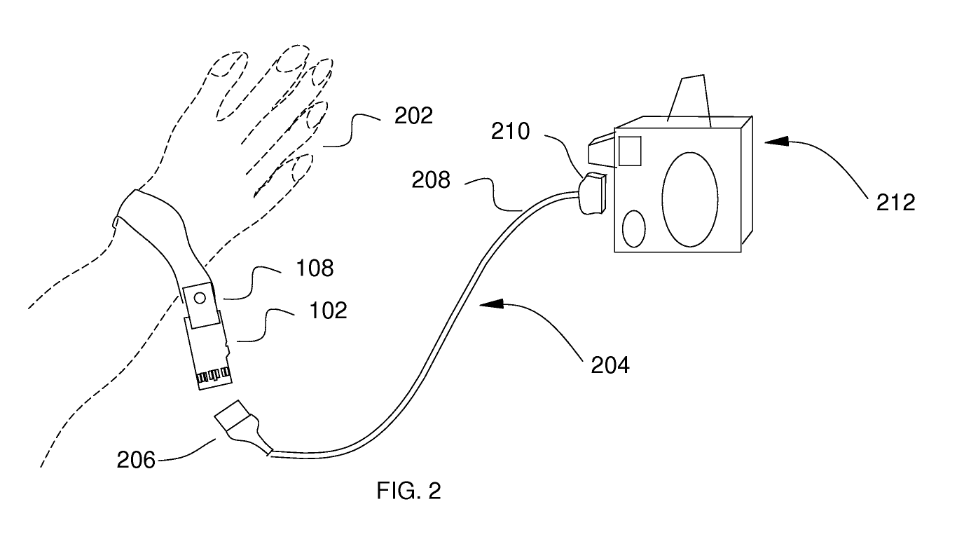

FIG. 2 illustrates the surgery monitor system for recording patient multimedia data using the components of the first embodiment. Portable storage device 102 is attached to a cable 204 having a first serial connector element 206 on one end of serial wire 208, and is operationally attached to a recording device 212 such as a video camera, using a second serial connector element 210. The first embodiment surgery monitor system ensures that portable storage device 102 remains uniquely associated with patient 202 since it remains attached to the patient armband 104 throughout the surgery preparation and execution procedures, and ensures confidentiality of patient information since it is a closed system.

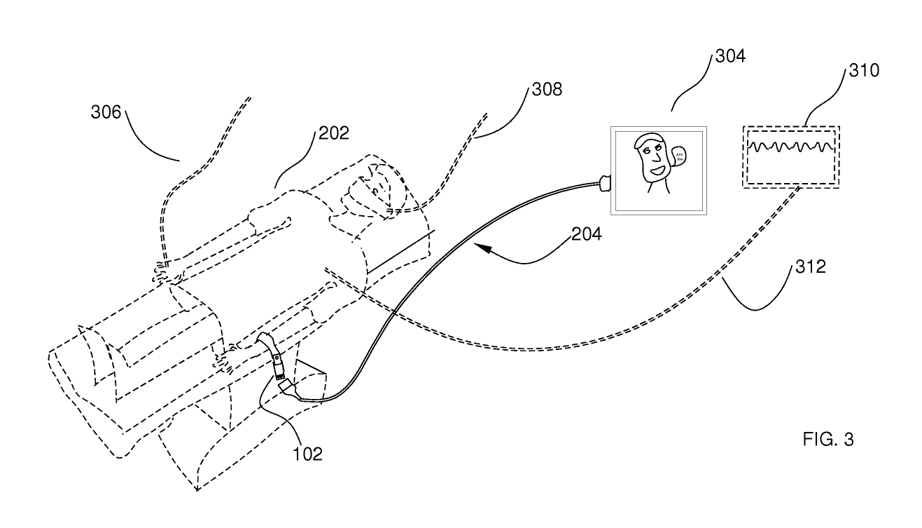

FIG. 3 illustrates the first embodiment being used for playback of previously recorded patient multimedia data, when a patient 202 is in the surgery room awaiting the surgery. The first embodiment playback components include the portable storage device 102, the cable 204, and a video playback device 304. Also illustrated are typical surgery room apparatus (not part of the first embodiment), e.g. an intravenous feed 306, an oxygen mask 308, a vital sign monitor 310 with vital sign cable 312 attached to patient 202. During the patient preparation, while in the surgery room waiting for the surgeon, when the surgeon is ready to operate, and during any official timeout procedure, the recorded patient multimedia data may be played back. The playback information presents the details of who the patient is, what he or she looks like, what the surgery is intended to do and where it is to be performed, the medical practitioner(s) performing the procedure, and any health related issues.

Other embodiments are included within the inventive concept presented herein. The video playback device may be replaced or augmented by an audio playback device. The SD card may be replaced by a thumb drive, a magnetic card strip, a CD-RW or DVD-RW disk, a smart card, a memory chip, a computer scannable image or other functionally equivalent devices. Additional recorded information may be added by a medical professional or another caregiver prior to the surgery, such as family history of allergies, and anything unusual occurring during the preparation period. The surgeon or others in the operating room staff may add comments during or after the operation about how the procedures went, and provide post-operative instructive or diagnostic information. The full recording can be made part of the patient record, and either the SD card or a copy of the recordings on the SD card made part of the permanent record. A device for playing back the patient multimedia data whenever a new person enters may also be included. The portable storage device may have barcode storage identification indicia that correlates with the barcode located patient identification indicia, and can be verified by a scanning device. In another variation of the first embodiment, the armband may be included in this variation, and the portable storage system is permanently attached to the variation. For this case, the combined portable storage system and armband may additionally have a protective cover that generally protects the portable storage system from contamination, yet allows the portable storage system to be available for access by the staff. This variation is particularly useful when the patient stay at the facility is for more than a day and protect the portable storage system when the patient showers.

Currently available commercial products are readily and inexpensively available for implementing the surgery monitor system of the first embodiment. For example, a Velocity Micro T103 Cruz Android 2.0 Internet Tablet has a Touch screen, a 512 MB storage device, Mini USB port, SD card and supports, Wi-Fi. An EASYi USB SD Card Reader for SD/SDHC Cards (Supports Windows Vista, ME, 2000 & XP). A 9.8-foot-long (3.0 meters) USB 2.0 A-Male to A-Female high-speed extension cable.

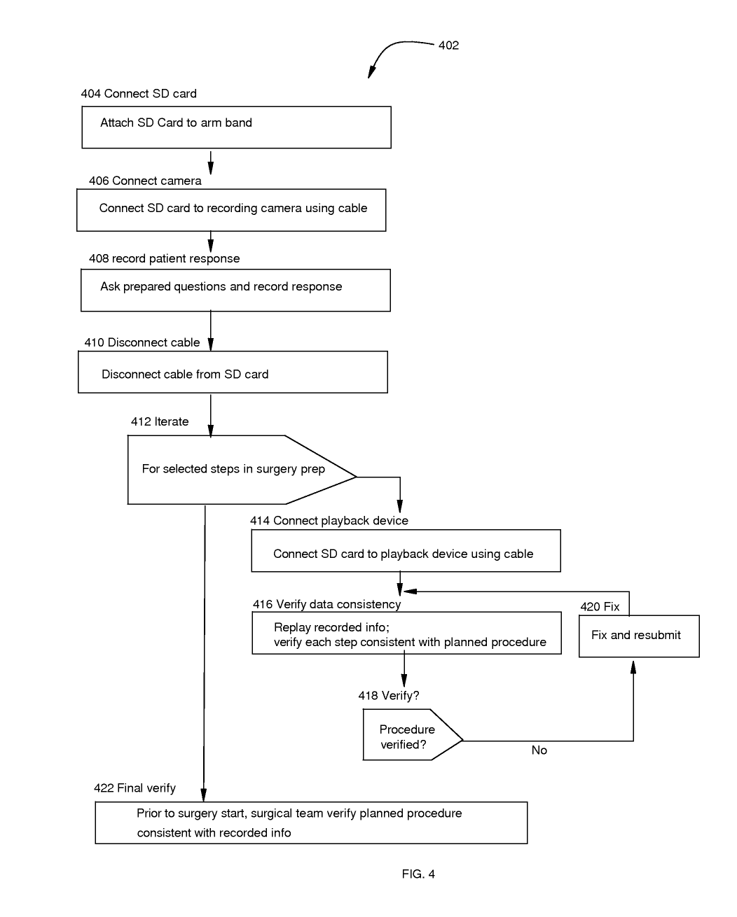

FIG. 4 is a flow diagram illustrating a method 402 for implementing the first embodiment of the present invention. Referring to FIGS. 2, 3 and 4, method 402 begins at the Connect SD card step 404, that is initiated after patient 202 has been admitted to the surgical facility, has an armband containing patient identification indicia installed, and has a chart/medical record containing patient 202 and planned surgical related data. In the connect SD card step 404, a hospital staff member attaches portable storage device 102 to patient armband 104. In connect camera step 406, a staff member operationally connects portable storage device 102 to recording device 212 using cable 204. In record patient response step 408, a staff member asks the patient identification related questions, health related questions, and planned procedure related questions, and records answers spoken by patient 202 (or guardian or nurse). The questions are typically prepared in advance by the surgery facility staff and stored in a first list, typically a written script. In disconnect cable step 410, cable 204 is disconnected from portable storage device 102.

The method then undergoes the iteration step 412, where the hospital staff prepares the patient for the scheduled surgery. The various surgery preparation procedures (move patient to operating room/procedure room, take vital signs, connect/insert invasive lines and perform region anesthetic pain blocks, surgical site preparation, surgical site draping to cover non-sterile body parts, etc,) are performed as indicated in iteration step 412. For each iteration, the SD card is connected to playback device 414 (if it is not already connected), and replays and verifies the data in consistency step 416. If the procedure is not verified during the verify step 418, the procedure is corrected during the fix step 420, and then resubmitted. When all the pre-operation procedures are complete and verified, control is passed to the final verify step 422. The surgical team verifies the planned procedure using the playback data. The actual preparation procedures where the iteration step loops over is typically incorporated in a second list prepared by the hospital staff.

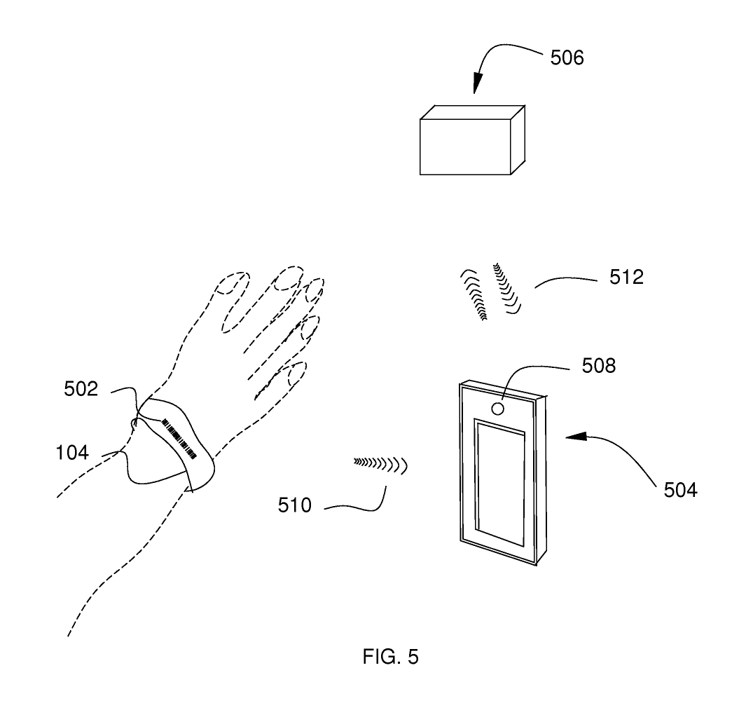

The rapid pace of emerging technologies related to video recording and playback using a smartphone type device, linear and 2D patient Identifying barcodes, server and cloud storage devices, and encrypted communication between the smartphone type devices and storage media allows the inventive concept presented herein to be implemented using these capabilities. Referring to FIG. 5, the patient armband 104 has a patient Identifying barcode 502 uniquely identifying the patient/surgery facility stay. A smartphone type device 504 containing a multimedia recorder 508, performs a patient identifying barcode scan 510 using a patient identifying barcode scanner installed on smartphone type device 504. The multimedia recorder 508 records the patient multimedia data, as in the first embodiment, and stores the information on a network server 506, which has a wireless, encrypted two-way connection 512 to the smartphone type device. During playback time, this, or an equivalent smartphone type device, will read the patient identifying barcode 502, transmit the barcode identification information to network server 506, and then receive the recorded multimedia via the server via the encrypted two-way connection 512 and play the patient multimedia data.

The disclosure presented herein gives several embodiments and several variations of the embodiments of the invention. These embodiments are to be considered as only illustrative of the invention and not a limitation of the scope of the invention. Various permutations, combinations, variations, and extension of these embodiments are considered to fall within the scope of this invention. Therefore, the scope of this invention should be determined with reference to the claims and not just by the embodiments and their variations presented herein.

1. A surgery monitor system for preventing wrong site medical procedures on a patient wearing a patient armband, said patient armband having patient identification indicia, said surgery monitor system comprising:
a portable storage device, said portable storage device being capable of storing patient multimedia data;
a recording device, said recording device being operationally connectable to said portable storage device;
a securing device attachable to said patient armband, said securing device also attachable to said portable storage device;
a playback device for playing back said patient multimedia data, said playback device being operationally connectable to said portable storage device
whereby said surgery monitor system is capable of recording said patient multimedia data during a first event, and additionally said surgery monitor system is capable of playing back said patient multimedia data during a second event.

2. The surgery monitor system of claim 1 further comprising at least one cable that operationally connects said portable storage device to said recording device and additionally at least one of said cables operationally connects said portable storage device to said playback device.

3. The surgery monitor system of claim 1 wherein said patient multimedia data is selected from a group consisting of patient name, patient date of birth, type of medical procedure, body location of medical procedure, patient allergies, patient health problems, patient image, and a combination thereof.

4. The surgery monitor system of claim 1 wherein said recording device is selected from a group consisting of a picture recording device, a video recording device, an audio recording device, and a combination thereof.

5. The surgery monitor system of claim 1 wherein said playback device is selected from a group consisting of a picture display device, a video playback device, an audio playback device, and a combination thereof.

6. The surgery monitor system of claim 1 wherein said portable storage device is selected from a group consisting of a thumb drive, a magnetic card strip, a CD-RW disk, a DVD-RW disk, a smart card, a memory chip, an SD card, and a combination thereof.

7. The surgery monitor system of claim 1 wherein said patient multimedia data is recordable by a group consisting of said patient, an admissions clerk, a patient caregiver, a patient nurse, and a combination thereof.

8. The surgery monitor system of claim 1 wherein said portable storage device has storage identification indicia that correlates with said patient identification indicia.

9. The surgery monitor system of claim 1 additionally comprising said patient armband and wherein said portable storage device is permanently attached to said patient armband.

10. A method for a surgical team preventing wrong site medical procedures on a patient wearing a patient armband, said patient armband having patient identification indicia, said method comprised of
a. providing a surgery monitor system having:
a portable storage device, said portable storage device being capable of storing patient multimedia data;
a recording device, said recording device being operationally connectable to said portable storage device;
a securing device attachable to said patient armband, said securing device also attachable to said portable storage device;
a playback device for playing back said patient multimedia data; said playback device being operationally connectable to said portable storage device;
a first cable for operationally connecting said recording device to said portable storage device;
a second cable for operationally connecting said recording device to said playback device;
whereby said surgery monitor system is capable of making a recording of patient multimedia data during a first event, and additionally said surgery monitor system is capable of playing back said patient multimedia data during a second event; and whereby said multimedia data correlates with said patient identification indicia;
b. performing the steps of:
acquiring a first list of questions to ask said patient, and a second list of preparation procedures where reviewing said patient multimedia data are to be performed;
attaching said portable storage device to said patient armband;
operationally connecting said portable storage device to said recording device;
asking questions from said first list of questions and recording responses;
disconnecting said first cable from said portable storage device for each preparation procedure on said second list:
connecting said portable storage device to said playback device using said second cable if said second cable is not already connected,
verifying said preparation procedure is consistent with said patient multimedia data,
if said preparation procedure is not consistent with said patient multimedia data, then fixing and repeating said preparation procedure,
prior to surgery start, said surgical team verifies said preparation procedure is consistent with said patient multimedia data.

11. A surgery monitor system for preventing wrong site medical procedures on a patient wearing a patient armband, said patient armband having a patient identification barcode that uniquely identifies said patient, said surgery monitor system comprising:
a smartphone type device, said smartphone type device additionally comprising a multimedia recorder, said multimedia recorder also comprising a first barcode scanner wherein said smartphone type device is capable of performing a barcode scan reading said patient identification barcode, said multimedia recorder additionally capable of recording said patient multimedia data;
a multimedia network server;
a wireless, encrypted two-way connection between said smartphone type device and said multimedia network server wherein said recorded patient multimedia data may be stored on said multimedia network server and uniquely identified by said patient identification barcode;
a playback device, said playback device being capable of wireless, encrypted two-way connection between said multimedia network server and said playback device,
said playback device additionally comprising a second barcode scanner wherein said second barcode scanner being additionally capable of reading said patient identification barcode thereby identifying said patient,
said playback device capable of playing back said recorded multimedia data uniquely identified by said patient identification barcode, said recorded multimedia data transmitted from said multimedia network server via said wireless, encrypted two-way connection.
